(19) United States
(12) Patent Application Publication
(10) Pub. No.: US 2015/0311567 A1
(43) Pub. Date: Oct. 29, 2015

(54) CHEMICAL BATTERY

(71) Applicant: Bill TODOROF, Laguna Beach, CA (US)

(72) Inventor: Bill Todorof, Laguna Beach, CA (US)

(21) Appl. No.: 14/652,254

(22) PCT Filed: Dec. 16, 2013
(86) PCT No.: PCT/US13/75443

§ 371 Date: Jun. 15, 2015

Related U.S. Application Data
(63) Continuation of application No. 13/842,736, filed on Mar. 15, 2013, now abandoned.
(60) Provisional application No. 61/737,256, filed on Dec. 14, 2012.

(51) Int. Cl. H01M 10/24; H01M 4/38; H01M 4/04; H01M 4/36

(52) U.S. Cl. CPC H01M 10/24; H01M 4/366; H01M 4/38; H01M 4/0471; H01M 4/0402; H01M 2300/0014

(57) ABSTRACT

The invention is directed to chemical batteries employing conductive and/or semiconductive electrode cores that are coated with at least one ceramic coating layer and methods of preparing the same. The batteries and/or battery cells include an electrolyte composition. The ceramic coating layer(s) provides a protective layer for the electrodes to prevent rapid corrosion. The ceramic coatings also serve to control energy and rate of ion exchange between the electrolyte composition and the electrode.

### CROSS-REFERENCE TO RELATED APPLICATIONS

This application claims priority under 35 U.S.C. §119 to U.S. application Ser. No. 61/737,256 filed Dec. 14, 2012, and application Ser. No. 13/842,736, filed on Mar. 15, 2013, which are herein incorporated by reference in their entirety.

### BACKGROUND OF THE INVENTION

Primitive saline batteries were developed some time ago and saline batteries have evolved since their inception. Saline is a suitable resource as it is one of the most plentiful natural resource. However, saline batteries have not been a preferable battery because they have suffered from a number of problems. For example, saline solutions and atmospheres are often highly corrosive to electrode materials. Lithium-ion batteries presently dominate the rechargeable, high-energy battery market. However, the voltage, charge capacity, battery life, and rechargeability of lithium cell batteries has largely been maximized. Moreover, lithium is in increasingly short supply and is expensive; thus, the cost of batteries is increasing while the battery technology is not improving. As such, there is a need for new battery technology that is capable of increasing the voltage, charge capacity, battery life, and/or rechargeability of the batteries. Furthermore, there is a need to reduce the cost of batteries.

### SUMMARY OF THE INVENTION

Accordingly, an object of the invention is to provide a battery with improved power and rechargeability. The battery includes a base structure having electrodes containing one or more ceramic coating layers. In an embodiment an inter-connective matrix can be formed between the electrodes. In an aspect of the invention, the ceramic coating layers protect the electrodes from corrosion due to the electrolyte composition. In another aspect the ceramic coating layers control the energy and rate of ion exchange between the electrode and electrolyte composition.

According to another object of the disclosure, a method of preparing a battery of the invention disclosed. The method includes providing a base structure having electrodes containing one or more ceramic coating layers. The batteries can be configured to have a high amperage output, to have a low gain in resistance, and to have a minimized loss across an interconnective matrix between the electrodes.

### BRIEF DESCRIPTION OF THE DRAWINGS

While the specification concludes with claims particularly pointing out and distinctly claiming the invention, it is believed that the various exemplary aspects of the invention will be better understood from the following description taken in conjunction with the accompanying drawings, in which:

FIGS. 1A and 1 B show two view of an embodiment of an electrode in a cylindrical geometry with a ceramic coating.

FIG. 2 shows a cross-section of an electrode demonstrating the increase in radius and multiple ceramic coating layers.

FIGS. 3A and 3B show exemplary relationships between the increase in resistance and radius of the ceramic coated electrode in embodiments of the invention.

FIG. 4 is a pictorial representation of an exemplary “plane plate cell” battery configuration in accordance with an embodiment of the invention.

FIGS. 5A and 5B are a pictorial representations of an exemplary “jelly roll cell” battery configuration in accordance with an embodiment of the invention.

FIG. 6 is a pictorial representation of an exemplary “button cell” configuration of electrodes in accordance with an embodiment of the invention.

FIG. 7 is a pictorial representation of an exemplary “button cell” battery configuration in accordance with an embodiment of the invention.

Various embodiments of the present invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION

The present invention relates to chemical batteries. The chemical batteries of the present invention have many advantages over existing battery technology. For example, the batteries of the present invention have a fast charge and discharge cycle lifetime—in some embodiments over 25,000 cycles—the batteries are re-chargeable, and have approximately 35% of the power storage capacity (˜1900 kWh) that an aluminum air battery (5500 kWhr) has. Furthermore, embodiments of the invention, including saline-based electrolyte batteries can be up to about 90% recyclable and to provide a large quantity of energy per Kg of weight. Moreover, such embodiments are inexpensive to produce, as the readily commercially available material costs for the electrode formulations are inexpensive.

The embodiments of this invention are not limited to particular batteries or battery cell configurations, which can vary and are understood by skilled artisans. It is further to be understood that all terminology used herein is for the purpose of describing particular embodiments only, and is not intended to be limiting in any manner or scope.

### DEFINITIONS

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

As used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range (e.g., 1 to 5 includes 1, 1.5, 2, 2.75, 3, 3.80, 4, and 5).

The terms “about” and “approximately” as used herein, refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

The terms, “cycles,” “cycle,” “cycle lifetimes,” and variations thereof refer to a one charge and one discharge equaling one cycle. Thus, by way of example, 25 cycles would be the equivalent of 25 charges and discharges.

The term “sparingly soluble,” as used herein, refers to an ingredient that is soluble in an aqueous carrier to an extent of less than about 20 wt-%, preferably less than about 10 wt-%, preferably less than about 5 wt-%, preferably less than about 3 wt-%. For example, an ingredient that is sparingly soluble in an aqueous carrier can be soluble to an extent of 20, 19, 18, 17, 16, 15, 14, 13, 12, 11, 10, 9, 8, 7, 6, 5, 4, 3, 2, 1, 0.9, 0.8, 0.7, 0.6, 10 0.5, 0.4, 0.3, 0.2, or 0.1 wt-%, to less than any of these weight percentages, to any of these weight percentages modified by about, or to less than any of these weight percentages modified by about.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The methods, systems, apparatuses, and compositions of the present invention can include, consist essentially of, or consist of the component and ingredients of the present invention as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

Aspects of the invention are directed at electrodes 12 with ceramic coatings 30, battery cells 10, and batteries 8. Embodiments of the invention may comprise, consist of, and/or consist essentially of an electrode 12 with a ceramic coating or a plurality of ceramic coatings 30. A further embodiment of the invention may comprise, consist of, and/or consist essentially of multiple electrodes 12 with ceramic coatings or a plurality of ceramic coatings 30. In an embodiment, the electrode(s) 12 is in an electrolyte composition 28. In a further embodiment of the invention, the invention may comprise, consist of, and/or consist essentially of a battery cell 10. Exemplary battery cell 10 configurations of the present invention, include, but are not limited to, plane plate cells, jelly roll cells, and button cells.

Electrodes

In an aspect of the invention, the batteries 8 and battery cells 10 of the present invention. Two broad classes of materials can be used to form the anodes 14 and cathodes 16 in the cells 10 that form the battery 8: native metals or semiconductors and their alloys, and conductive ceramics.

In the case of native metals, semiconductors and their alloys the electrochemical potential of the material and its suitability as a conductor to collect current and move it toward a terminal are the deciding factors in which materials can be combined to form a cell suitable for storing electrical energy. Electrical resistance and electrochemical potential are used to select appropriate pairings of anode and cathode electrodes 14, 16. Suitable metals for use as the electrode conductive core 18 include, but are not limited to, noble metals (gold, platinum, iridium, palladium, osmium, silver, rhodium, and ruthenium), mercury, polonium, copper, bismuth, technetium, rhenium, antimony, magnesium, aluminum, n-doped silicon, zinc, iron, chromium, manganese, and alloys of the aforementioned. The noble metals are generally more resistant to corrosion; however, they are significantly more expensive than other metals and alloys. Table 1 provides a list of preferred materials for electrodes 12.

TABLE 1

| Cathode Materials | Anode Materials |
|---|---|
| Zn/Fe alloys | Cu |
| Elemental Zn | Mn |
| Al | Mn/Cr/Mg alloys |
| Al alloys with Si and Fe | Cu/Cr/Fe alloys |
| Heavily n-doped Si | Mn/Cu/Mg alloys |
| C | Si |

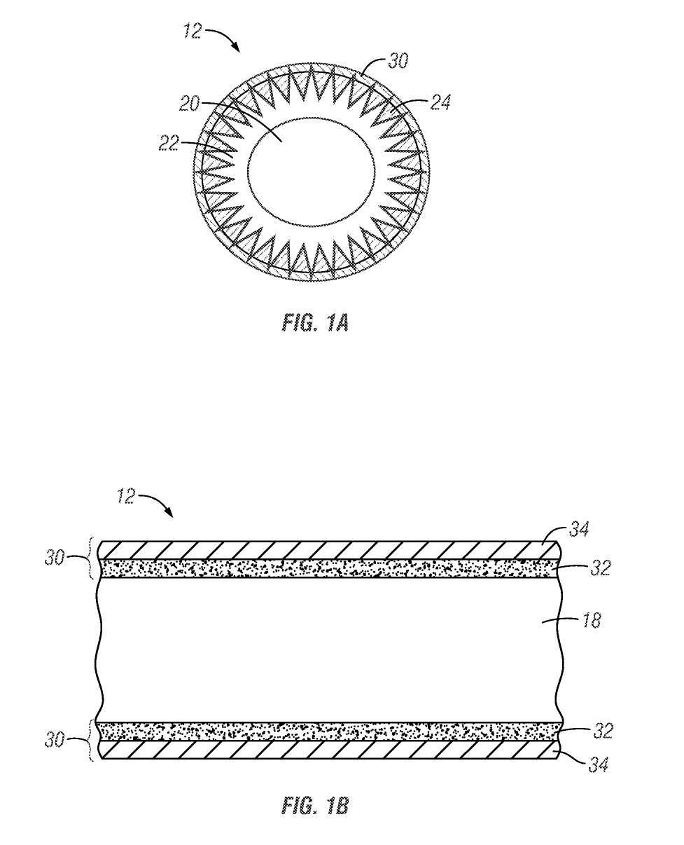

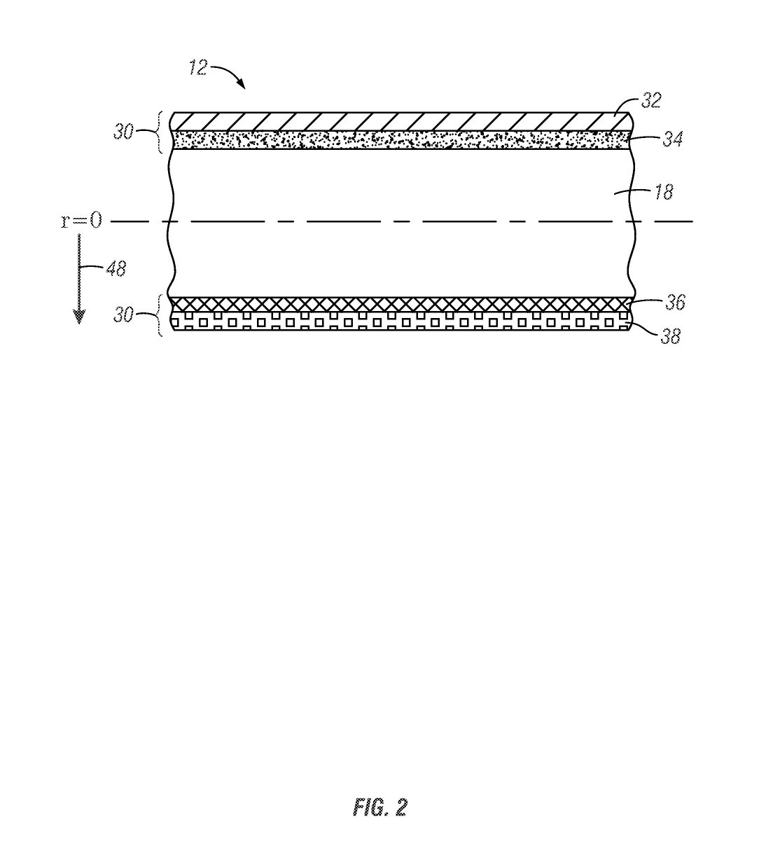

The materials provided in Table 1 can be used in bulk as both the anode/cathode 14, 16 to form the conductive/semiconductive core 18 and the bearer of the derived current when the battery 8 is in use via their low resistance and highly mobile charge carriers. As such, these materials for the conductive/semiconductive core 18 are coated with ceramic materials 30 to control corrosion and the rate and potential of electrons participating in reaction with an electrolyte 28 as desired (see FIGS. 1A, 1B, and 2).

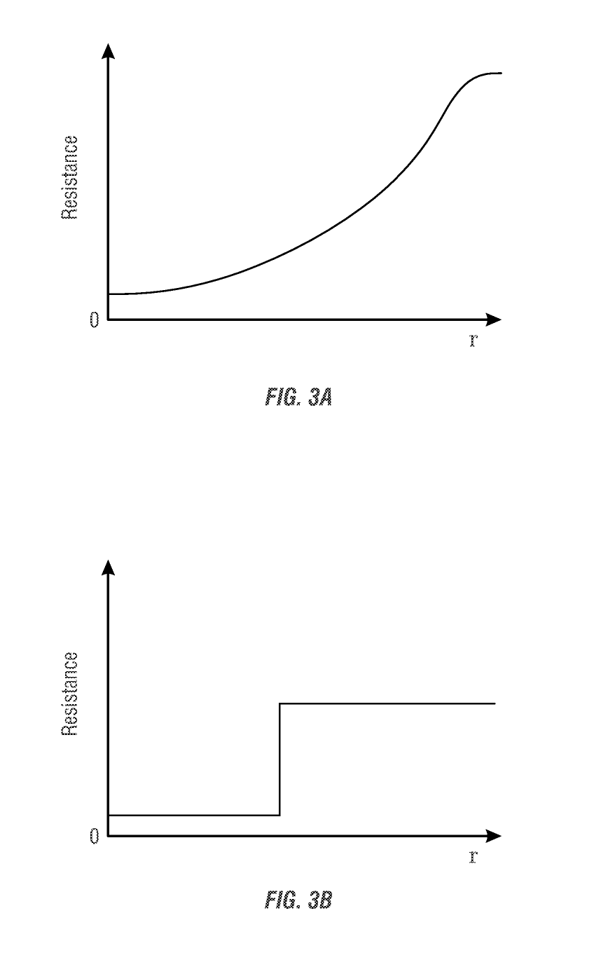

Electrodes 12 of the present invention can comprise ceramic metal glasses. Ceramic metal glasses comprise at least three of a flux, a refractory ceramic, a modifier, and a metal to form a ceramic metal glass with conductive or semiconductive properties. This ceramic metal glass forms the conductive/semiconductive core 18. By varying the composition of the ceramic metal glasses and how they are formed, the resistance and electrochemical properties of the materials can be adjusted in both smooth variable (FIG. 3A) and sharp stair-step (FIG. 3B) ways. These ceramics may be highly insulated or semiconductive metalloids with resistances that vary from 0.5 to hundreds of ohms. Prior to firing of these ceramics, it is also possible to embed conductive cores of metals or semiconductors in the center of the ceramic material, resulting in sharp stair-step profiles of resistivity versus radial distance from the center of the electrode 12 (FIGS. 2 and 3B). This latter case is particular helpful where a ceramic may not have the desired ability to transport current along an elongated electrode 12 efficiently enough for a given electrochemically active ceramic (e.g. a semiconductive metalloid.)

FIG. 2 shows an embodiment of an electrode demonstrating the increase in radius 48 extending from the approximate center axis of the electrode conductive/semiconductive core 18. The electrode 12 of FIG. 2 can be any geometrical shape (e.g., planar, cylindrical, corrugated). In an aspect, the electrode 12 of FIG. 2 has a plurality of ceramic coating layers 30, a first layer 32, second layer 34, third layer 36, and a fourth layer 38. In the embodiment of FIG. 2, there may be additional ceramic coating layers. Depending on the geometrical shape and/or desired application or properties, the first and fourth layers 32, 38 can be the same material or different materials, and the second and third layers 34, 46 can be the same material or different materials.

Various raw earth materials may be selected (and blended) to achieve a higher resistance for use as a conductive/semiconductive core 18. This can result in a longer lifetime and a relatively high energy efficiency. A few blended semiconductive electrode 12 formulations, provided by way of example, are as follows:
1) Lithium, Alumina Silicates=Li/AL/Si in the rough blend of 20% Lithium, 20% Alumina (AL) and 60% Silica, leads to a very fast Electrical semi-conductor in thin cross sections that is very corrosive resistant in a saline environment, with a crystalline formulation temperature of around 1260-1320° C.
2) Lithium, however, has become an expensive material due to its high demand and rare availability. Therefore modifying the semi-conductive alloy to Ca 18%, Li 6%, AL 18%, Si 58%, reduces the cost by approximately 35% albeit it raises the crystalline formation temperature around 30° C., it also makes it slightly less efficient Electrical semi-conductor, and conversely more corrosion resistant in a saline environment.
3) Eliminating lithium reduces the cost again, even by another 15%, or overall 50% less expensive than the first presented semi-conductive electrode alloy. Thus, a less expensive alloy may have a basic formulation as follows: Ca 6%, Ba 7%, Bi 11%, AL 16%, and Si 60%. This alloy may have a crystallization formation temperature of around 1220-1280° C., and it may be a more efficient Electrical semi-conductor as well as being a more corrosion resistant alloy in a saline environment. Thus, embodiments of the invention contain no more than 10 wt. % lithium, preferably no more than 9 wt. % lithium, more preferably no more than 8 wt. %, still more preferably no more than 7 wt. % lithium, even more preferably, no more than 5 wt. % lithium. In another embodiment, the electrodes are substantially free of lithium.
4) Adding a small amounts of Copper (Cu), between about 0.5 wt. % and about 5 wt. %, preferably about 2 wt. %, and/or Iron (Fe), between about 1 wt. % and about 7 wt. %, preferably about 5 wt. %, allows the alloy to have room temperature super-conductivity, in a below Zero temperature range, thereby making this semi-conductive alloy more electrically conductive than either Aluminum and Copper respective to the below zero temperature.
5) Adding Titanium (Ti) in the form of the low cost naturally occurring mineral Rutile which is approximately 93% Ti and 7% Fe so the resultant formulation may be, for example, Ca 6%, Ba 7%, Bi 11%, AL 16%, Rutile (Ti Fe) 11%, Cu 2%, and Si 47%, by a molecular weight blend. This semi-conductive electrode demonstrates improved corrosion resistance in a saline environment, with an electrical conductivity that approaches that of 97% pure aluminum and may have an operational lifetime with more than 75% efficiency in over 25,000 cycles in a saline battery. At an electrode cost of less than copper, it is 80% as conductive and will last 25 times longer than copper in a saline environment.
6) Further additions of Phosphorous (P) between about 10 wt. % and about 20 wt. %, preferably about 15 wt. %, may extend the electron travel lifetime in the alloy by as much as 50%, and may increase the semi-conductive alloy to an electrical conductivity in between that of aluminum and copper while still maintaining an over 25,000 cycle lifetime in a saline battery.
7) The alloys may be hardened by adding up to 6% of Boron Trioxide (B₂O₃), which addition may reduce the crystalline formation temperature about 25-30° C. A semi-conductive alloy of approximately this general formulation may include, for example, about: Ca 6%, Ba 7%, Bi 11%, AL 16%, P 16%, Rutile (Ti Fe) 11%, Cu 2%, 6% B₂O₃, and Si 25%, by a molecular weight blend. In such an embodiment the crystalline formation temperature between about 1120-1160° C. This electrode would provide at least about 25,000 cycle lifetimes at over 80% efficiency in a saline based battery.

In an embodiment of the invention, the electrode 12 comprises a conductive/semiconductive core 18, interfacial core 22, and/or outer core 24. The interfacial and outer cores 22, 24 can be textured layers to increase the surface area of the electrodes 12 as desired. Such texturing can be formed by ‘whiskers’ of the ceramic coatings 30 produced by adjusting the firing conditions of the layer during production, or can be grown on the ceramic layer 30 such as in the form of carbon nanotubes. These texturing layers may be produced out of the outermost layer of a coating 30, or deposited out of a second different material that acts solely to assist in charge transfer across the ceramic layers to the underlying electrode material 18. This texturing can be assisted by the addition of one or more modifiers to the unfired ceramic material as is known in the art.

Electrodes 12 of the present invention may be in any suitable geometric shape. In embodiments, the electrodes 12 can be planar, round, parallel plates, corrugated, etc. Those of skill in the art are aware of and can appropriately select the desired geometry for the electrode 12. FIGS. 1A and 1B show an embodiment of an electrode 12 in a cylindrical geometry. The electrode 12 of FIG. 1A has a conductive/semiconductive core 18, interfacial core 22, outer core 24, and a ceramic coating or plurality of ceramic coatings 30. FIG. 1B shows cross-sectional view of a cylindrical electrode with a conductive/semiconductive electrode core 18 and multiple ceramic coatings 30, a first ceramic coating layer 32 and a second ceramic coating layer 34. The use of two ceramic coatings 30 is only illustrative and shall not be construed as limiting. Embodiments of the invention may include a plurality of ceramic coating layers as described herein.

In an aspect of the invention, the electrodes 12 may be printed on ceramic tile. In a particular embodiment of the invention, SIALON ceramic tiles are preferred. In still a further embodiment the SIALON tiles have a thickness of about 1.72 mm

Ceramic Coatings

Ceramic coatings 30 are used to controllably passivate the surface of electrodes 12 that would otherwise be victim to substantial corrosion resulting in a non-rechargeable cell. The ceramic coatings 30 operate by controlling the energy and rate at which ions transfer between the electrolyte 28 and electrode 12. In an embodiment of the invention there may only be one ceramic coating layer 30. In a further embodiment of the present invention there may be a plurality of ceramic coating layers 30. In an embodiment with a plurality of ceramic coating layers, there may be at least 2, at least 3, at least 4, at least 5, at least 6, at least 7, at least 8, at least 9, at least 10, at least 12, at least 15, at least 20. In another aspect of the invention, the thickness of the ceramic coatings 30 is not critical to the invention as claimed; however, the thickness can be critical to the desired application, i.e., for controlling the energy and rate of ion transfer between the electrolyte 28 and the electrode 12. In an embodiment the ceramic coatings 30 may be at a scale ideally measured in nanometers and in a further embodiment at a scale ideally measured in millimeters.

The ceramic coatings 30 can be deposited by processes known in the art such as ink-jet printing, microspray, electrostatic patterning, and/or vapor deposition. These coating materials are then heated (also referred to as firing) to a sufficiently high temperature that the material fuses into a desired ceramic coating. In an embodiment of the invention, individual ceramic coating layers are added and fired sequentially; for example, a first coating is added and fired, then a second coating is added then fired, etc. However, in another embodiment of the invention, multiple ceramic coating layers are added and then fired simultaneously. The ceramic coatings 30 are in general formed of a high melting temperature refractory material, a low melting temperature flux, and a modifier material that impacts the melting temperature of the complete mixture, the resultant ceramic's crystal morphology, and surface texture.

In an embodiment where multiple ceramic coating layers are heated simultaneously, it is preferred if at least two, more preferred if at least three, even more preferred if all four of the ceramic coating materials, i.e., refractory, modifier, metal, and flux, are selected based on having eutectic temperatures within a range of between about 500° C., preferably within a range of between about 400° C., more preferably within a range of between about 300° C., even more preferably within a range of between about 200° C., still even more preferably within a range of between about 100° C. Mixtures of each of these three constituent materials are formulated so that the resultant ceramic layer 30 has the desired porosity, resistance, and a coefficient of thermal expansion closely matched to that of the material it is being deposited on (e.g., an electrode surface or other thin ceramic layer).

Suitable examples of the ceramic materials used in both electrodes 12 and the ceramic coating layers 30 used on top of the electrode and ceramic electrodes include, but are not limited to those provided in Table 2. It is important to note that although some species in Table 2 are chemically a metal (e.g., elemental calcium) in the composition of ceramic the melting temperature and impact on a eutectic melt of said ingredient on the pre-heated mixture is often as important as it traditional chemical properties such as conductivity. For example, electrodes often require crystalline morphology best formed at firing temperatures 100° C. below the melting point of the unheated composition to have adequate conductivity.

TABLE 2

| Refractory | Modifier | Metal | Flux |
|---|---|---|---|
| Carbon | Calcium | Bismuth | Borax |
| Graphene | Dolomite | Iron | Sulfur |
| Titania | BaC | Titanium | Phosphorus |
| Rutile | SrC | Neodymium | NaCl |
| Boron | Mg | Copper | H (gaseous) |
| MnO₂ | Wollastonite | Aluminum | Lithium |
| ZnO₂ | Feldspars (K-spar, | Zinc | Fluorite |
| | plagioclase etc.) | | |
| SnO₂ | Sphaelerite | Selenium | Sodium |
| | | | Hypochlorite |
| SiO₂ | Tourmaline | Chromium | Polymers (e.g. |
| | | | polypropylene |
| | | | beads) |
| Si | Polymers (e.g. | Cobalt | Elemental Iodine |
| | polypropylene | | |
| | beads) | | |
| SiC | | Mercury | |
| Al₂O₃ | | Titanium Nitride | |
| Pr | | Cobalt Nitride | |
| Dy | | | |
| Spodumine | | | |
| Petalite | | | |
| Bauxite | | | |

Electrolyte Compositions

In an aspect of the invention, the batteries comprise electrolyte compositions. When electrodes are placed in an electrolyte and a voltage is applied, the electrolyte will conduct electricity. Lone electrons normally cannot pass through the electrolyte; instead, a chemical reaction occurs at the cathode consuming electrons from the anode. Another reaction occurs at the anode, producing electrons that are eventually transferred to the cathode. As a result, a negative charge cloud develops in the electrolyte around the cathode, and a positive charge develops around the anode. The ions in the electrolyte neutralize these charges, enabling the electrons to keep flowing and the reactions to continue.

The electrolyte composition may comprise, consist of, or consist essentially of a liquid phase. In an embodiment the electrolyte composition may comprise, consist of, or consist essentially of a liquid phase and solid phase. The liquid phase may be prepared, contained within the battery cell, or even a naturally occurring electrolyte solution. In embodiments of the invention, the electrolyte composition comprises, consists of, or consists essentially of saline electrolyte. Saline electrolytes function as an electron carrier fluid as well as being electrically conductive and capable of very rapid ion exchange before they reach their highest level of exhaustion, and their evaporation limit, by boiling away, into a vapor.

Examples of suitable liquid phases include, for example, aqueous solutions of one or more of the following species: alkali metal chlorides (e.g., NaCl, KCl); alkali metal hydroxides (e.g., NaOH, KOH); alkali metal phosphates (e.g., KH₂PO₄); alkali metal sulfates (e.g., Na₂SO₄); magnesium sulfate hydrate; and sodium silicate.

In an aspect of the invention, an electrolyte solution can also be a naturally occurring fluids such as seawater, geothermal brines, blood, or other biological fluids that are aqueous in nature. Electrolytes can be found in nature and used in-situ and need not be prepared or exceptionally pure to produce a functioning cell.

In an aspect of the invention, the electrolyte composition 28 can be added directly to the battery 8 or battery cell 10. In another aspect of the invention, the battery 8 or battery cell 10 can be added to an electrolyte composition, such as one of the aforementioned naturally occurring fluids. In another aspect of the invention, the electrolyte composition 28 can be added at one time (all at once), continuously, or periodically. In another embodiment of the invention, the electrolyte composition 28 can be periodically purged from the battery 8 and/or battery cell 10; in such an embodiment electrolyte compositions 28 are typically replenished simultaneously or sequentially in a periodic manner. In yet another embodiment the electrolyte may be at least partially exchanged, continuously or periodically, with an outside environment.

In addition to the liquid phase, the electrolyte composition may optionally comprise, consist of, or consist essentially of a solid phase. In such an embodiment, the solid phase acts as a suspension agent allowing for reduced quantities of water to be used in the electrolyte, or to suspend additional species that participate in the electrochemical reaction. Examples of suspension agents include, but are not limited to, phylosilicates and polymers. Examples of phylosilicates, include, but are not limited to, bentonite, kaolinite, montmorillionite, ball clays, and mixtures thereof. Polymers useful in the electrolyte compositions of the present invention are those that absorb many times their own weight in aqueous solutions. Examples, include, but are not limited to, cellulosic polymers (e.g., carboxymethyl cellulose, hydroxyethyl cellulose); polyacrylates (e.g., sodium polyacrylate); polyacrylimides; and hydrocolloid thickeners (e.g., pectin). The solid phase may be soluble in water or sparingly soluble.

These suspension agents can also have the effect of lowering the amount of water present in the electrolyte below that required for a saturated solution of the salts used to generate the electrochemical cell. Species can be suspended in contact with the aqueous phase that are sparingly soluble or insoluble with water alone. For example, experiment has shown that the presence of elemental sulfur that is not normally soluble in aqueous solutions alone can be suspended in a clay gel or paste with a liquid electrolyte and yield an increase in the voltage of the cell.

In this manner solid constituents that would not be soluble in the liquid phase alone are put in contact with the electrolytic composition and can participate in the reactions. Finally use of a suspension agent allows for the prevention of electrolyte leaks as the bulk of the aqueous phase is suspended within the solid phase rendering it viscous.

### EMBODIMENTS OF THE INVENTION

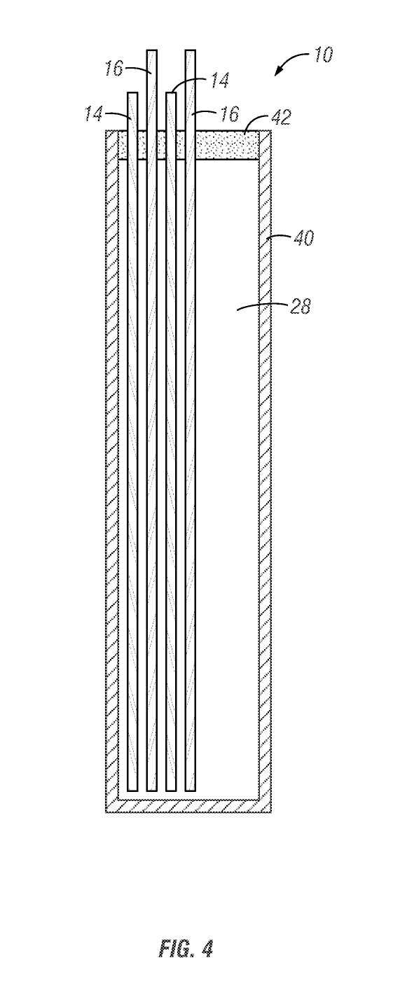

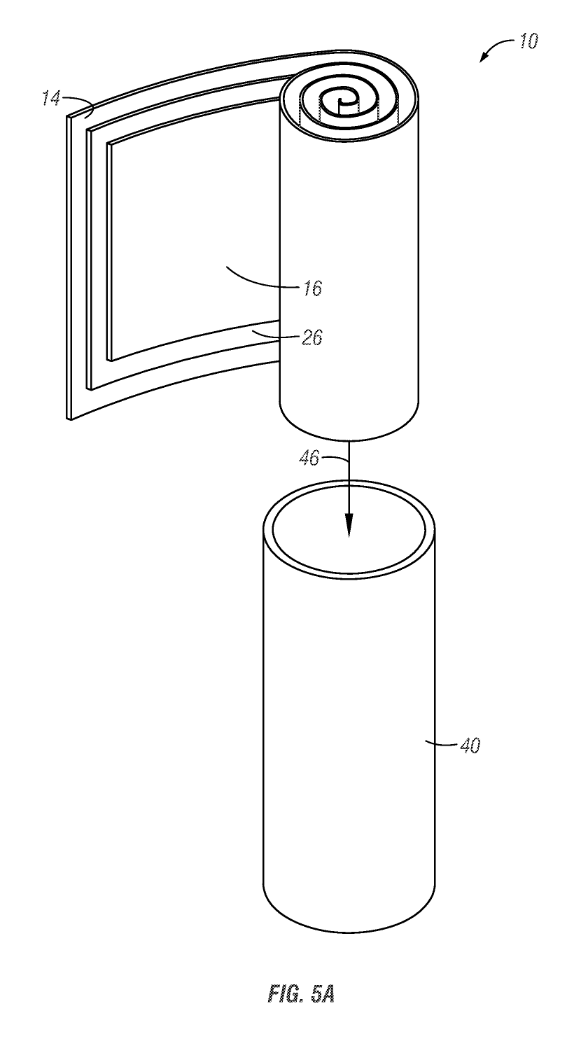

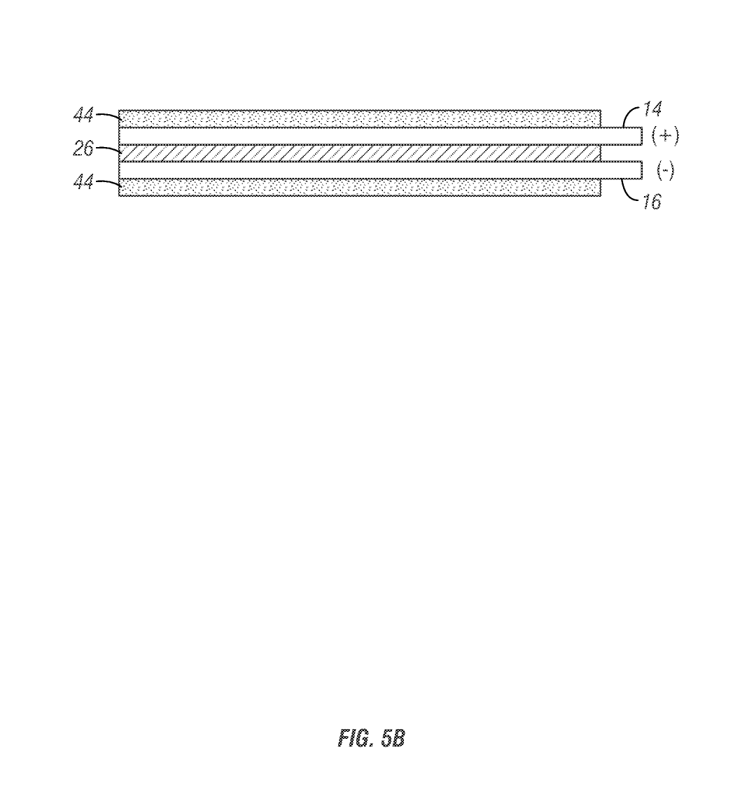

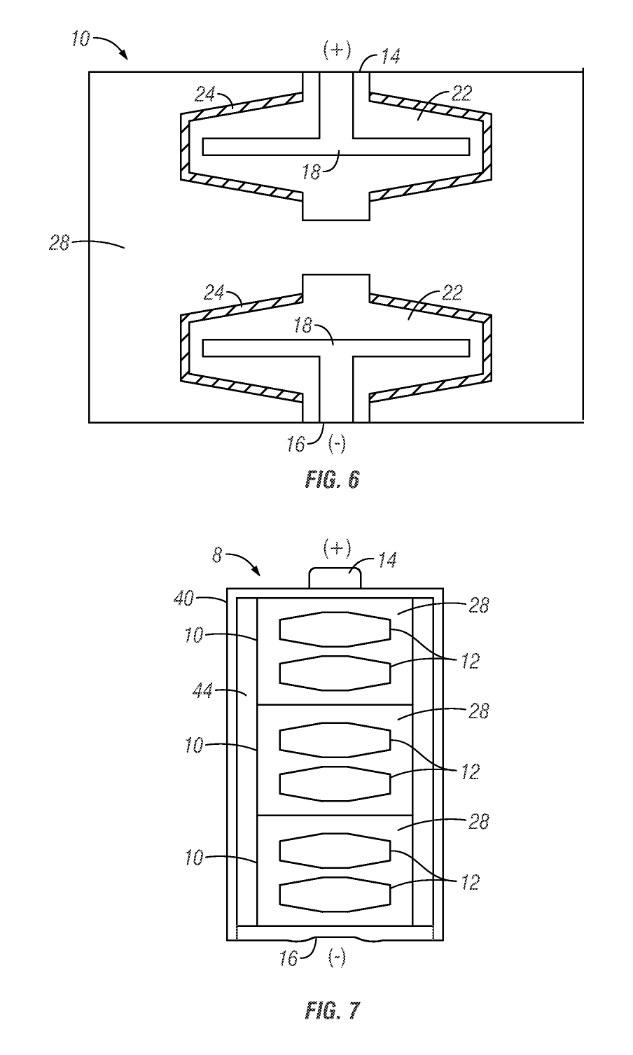

The electrodes 12 of the present invention can be organized in a battery cell 10. Individual or multiple battery cells 10 may comprise a battery 8. The present invention is not limited to any battery configuration, energy, or size. Such things can be dictated by the desired application for the battery and those of skill in the art are capable of preparing batteries for their desired application (e.g., automotive battery, radio battery, AA batteries). Exemplary configurations include, but are not limited to, plane plate cells (FIG. 4), jelly roll cells (FIGS. 5A and 5B), and button cells (FIGS. 6-7).

In an embodiment of the present invention, the battery cells may be placed in a containment structure 40 (see FIGS. 4, 5A, and 7). Suitable containment structure 40 materials and configurations are known by those of skill in the art. In an environmentally beneficial embodiment, the containment structure 40 may be formed from a recycled polycarbonate material. In another aspect of the invention, a battery containment structure 40 can be designed to permit contain and/or provide a charge and discharge control system being configured to charge and discharge one or more of the disclosed batteries is contemplated.

In a further aspect of the invention, the battery 8 can be designed to have a sealant 42 to replace part, all, or none of the containment structure 40. FIG. 4 illustrates an embodiment of a plane plate cell 10 with a containment structure 40 and a sealant 42 that replaces the top closure portion of the containment structure. However, in another embodiment, the sealant 42 could be replaced by the containment structure 40. The plane plate cell of FIG. 4 has electrodes 12 contained within the containment structure and provides alternating anodes 14 and cathodes 16 in an electrolyte composition 28. In this particular configuration, the electrodes share the electrolyte composition 28; however, other embodiments separate each cell 10 into separate electrolyte 28 solutions. Still in a further embodiment of the invention, a sealant 42 could be added in addition to the containment structure 40, as opposed to replacing it.

In a further embodiment of the invention, the battery cell 10 may include an interconnective matrix 26 between electrodes 12. (See, e.g., FIGS. 5A and 5B). The interconnective matrix between the electrodes provides a synergistic reduction in excess of entropic losses. In another aspect the interconnective matrix 26 control leakage if the cell were to rupture. In an embodiment of the invention, the interconnective matrix 26 can comprise SIALON tiles having cross-linked crystalline reinforcing matrix. In such an embodiment, the SIALON tiles can be grown internally. In another embodiment of the invention, the interconnective matrix 26 can comprise a fabric mat, such as a polymeric fabric. The interconnective matrix 26 includes or is kept within the electrolyte solution 28. FIG. 5A illustrates a jelly roll cell configuration, where the battery cell 10 is placed 46 within a containment structure 40. The anode 14 and cathode 16 are integrated with an interconnected matrix 26. In an aspect of the invention, the battery cell may further comprise an insulating separation 44 (FIG. 5B) between the cell rolls.

FIG. 6 shows a button cell 10. The anode 14 and cathode 16 are separated by electrolyte 28 and comprise a conductive/semiconductive electrode core 18, an interfacial layer 22, and an outer layer 24. In an embodiment the conductive/semiconductive core 18 can provide a low resistance zone and the interfacial and outer cores 22, 24 provide a higher resistance in order to control the ion flow between the electrolyte composition 28 and the electrodes 12.

FIG. 7 shows a battery 8 with a three button cells 10; however, batteries 8 containing a plurality of cells can be configured if so desired. The battery 8 has a containment structure 40 and insulating separator 44. Moreover, this embodiment of the invention illustrates a battery 8 configured so that each battery cell 10 has its own separate electrolyte composition 28. In another embodiment, the battery 8 could be configured so that the cells 10 all share an electrolyte composition 28.

In another aspect of the present invention, the battery 8 is rechargeable and/or can be substantially renewed by reversing the ion flow between the electrodes 12. In a preferred embodiment the battery may be renewed by more than about 99%, 98%, 97%, 96%, 95%, 90%, 85%, 80% of the original charge.

### EXAMPLES

### Example 1

### Al—Cu Saline Battery with Ceramic Layers

In an embodiment of the present invention, a bulk aluminum cathode is coated with a ceramic layer composed of 50% petalite, 20% tin oxide and 30% lithium carbide by weight. This first thin film ceramic coating is then fired at 1160° C. to the eutectic melting point of the mixture yielding a thin film less than 10 microns thick after returning to solid form with a resistance of approximately 5 ohms. Next, a second thin ceramic layer is deposited atop the first layer composed of 58EM (described in Table 3 below) also fired to its eutectic point. This second ceramic layer was selected because it will provide a porous less resistive outer layer as the pores add effectively zero resistance to the combination of the two layers in series. Additionally the porosity of this second ceramic layer controls the rate at which ions from the electrolyte can interact with the aluminum cathode.

A third film was deposited atop the film of 58EM after it is fired. The third film was composed of a blend of 38%(wt) 58EM, 15% Magnesium, 15%(wt) zinc oxide, 15%(wt) lithium carbide and 17%(wt) calcium magnesium sulfate. This film is also raised in a kiln to its eutectic point resulting in a porous film of low resistivity.

TABLE 3
58EM Ceramic Composition (wt. %)

| | |
|---|---|
| Carbon | 40% |
| Phosphorus | 22% |
| Silicon | 8% |
| Titanium | 12% |
| Iron | 4% |
| Copper | 2% |
| Sulfur | 8% |
| Oxygen | balance |

An anode of bulk copper plate was coated with a first ceramic thin film of 50-50% (wt) Cu—C ceramic and fired to its eutectic point generating a film of several microns in thickness. This film interacts directly with the electrolyte.

An electrolyte of 7%(wt) calcium magnesium sulfate and 10%(wt) sodium chloride with the balance water is placed between the coated cathode and anode, thus forming the galvanic cell of the present invention. Optionally, a fabric mat of polymer fabric can be used as an interconnective matrix to hold the electrolyte composition between the anode and cathode and control potential leakage of the electrolyte composition should the containment structure around the cell rupture.

### Example 2

### Solid-Phase Electrolyte Battery

Using the electrode composition of Example 1, a battery can be prepared where the electrolyte is further enhanced by the suspension of species not otherwise readily soluble, or sparingly soluble in water.

The electrodes of Example 1 above are formed as previously taught for the anode and cathodes. Alternatively, these anodes and cathodes may be of a completely ceramic metal glass structure (as described above). As has been previously taught, the resistance and other chemical properties of the ceramic electrode may be adjusted to create both a smooth continually varying electrical property from the inside to the outside of the electrode, or a more abrupt stair-step profile (see FIGS. 3A and 3B).

The electrolyte is formed of the following materials using an absorptive phyllosilicate as a suspension agent such as montmorillionite or kaolinite. Additionally, elemental sulfur powder is added at about 10 wt. % and is suspended in the electrolyte paste allowing for the formation of complex sulfur polymer species and adjuvants to the electrochemical process of energy storage.

As the sulfur atom, though not directly soluble in pure water solution alone, can host as many as 2.0 lithium atoms from an electrode or indirectly participatory Li-bearing ceramic coating with increased energy storage evinced. This is in contrast to the lithium polymer batteries of the prior art where as few as a half of lithium atoms can be accommodated in a single sulfur atom of such a system. Thus the addition of even a scant amount of otherwise insoluble sulfur allows for marked improvement in cell voltage and energy density.

A saturated solution at a temperature of 100° C. of sodium chloride is formed using water as the solvent. To this mixture approximately 5-7 wt. % of suspension agent is added creating a paste or gel. This suspension agent may be an absorptive clay or a polymer such as a hydrogel for example polyacrylate or polyacrylimide polymers either alone or together. Cellulosic polymers may be used as well. Physical and chemical gels are thus used to suspend the aqueous electrolyte and other species in the electrolytic material as needed. Crosslinking or aggregation through hydrogen or a polymer network attracted together by aggregation of polymer chains or side groups using hydrogen and van der Waal's attractions to form a sol or gel.

This gel or paste electrolyte is then juxtaposed between the electrodes forming the cell of the battery.

Embodiments of the present invention have been set forth in the drawings and the specification and although specific terms are employed, these are used in the generically descriptive sense only and are not used for the purpose of limitation. Changes in the form proportion of parts as well as substitution of equivalents are contemplated as circumstances may suggest or are rendered expedient without departing from the spirit or scope of the invention as further defined in the following claims.

What is claimed is:

1. A chemical battery comprising:
at least one cell comprising at least two electrodes, wherein the at least two electrodes comprise an anode and a cathode, and wherein the electrodes have at least one ceramic coating layer comprising a refractory, modifier, metal, and flux.

2. The battery of claim 1 further comprising an interconnective matrix between the anode and cathode.

3. The battery of claim 1, wherein the at least one ceramic coating layer is a plurality of ceramic coating layers.

4. The battery of claim 1 further comprising an electrolyte composition.

5. The battery of claim 1, wherein the base structure comprises a containment structure.

6. The battery of claim 1, wherein an anode comprises a metal or metal alloy selected from a group consisting of copper, manganese, magnesium, iron, chromium, silicon, alloys of the aforementioned, or combinations of the same; and wherein the cathode comprises a metal or metal alloy selected from a group consisting of iron, zinc, aluminum, silicon, n-doped silicon, carbon, alloys of the aforementioned, or combinations of the same.

7. The battery of claim 1, wherein the electrodes comprises a ceramic metal glass comprising at least three of the following lithium, aluminum, alumina, silicon, silicon dioxide, alumina silicate, barium, bismuth, calcium, copper, titanium, rutile, phosphorous, boron trioxide, or combinations thereof.

8. The battery of claim 1, wherein the battery is rechargeable or substantially renewed by reversing the ion flow between the electrodes.

9. The battery of claim 1 further comprising at least three cells, wherein the electrolyte material is contained separately in each cell.

10. A battery cell comprising:
an anode comprising a metal, metal alloy, or ceramic metal glass;
a cathode comprising a metal, metal alloy, or ceramic metal glass;
wherein the anode and cathode have at least one ceramic coating layer comprising at least three of a refractory, modifier, metal, and flux.

11. The battery cell of claim 10, wherein the at least one ceramic coating layer is a plurality of ceramic coating layers.

12. The battery cell of claim 10 further comprising an electrolyte composition, wherein said electrolyte is added one time, continuously added, periodically purged and added, or at least partially exchanged with an environment.

13. The battery of claim 1, wherein the anode and cathode are ceramic metal glass comprising at least three of the following lithium, aluminum, alumina, silicon, silicon dioxide, alumina silicate, barium, bismuth, calcium, copper, titanium, rutile, phosphorous, boron trioxide, or combinations thereof.

14. The battery of claim 1, wherein the anode comprises a metal or metal alloy selected from a group consisting of copper, manganese, magnesium, iron, chromium, silicon, alloys of the aforementioned, or combinations of the same; and wherein the cathode comprises a metal or metal alloy selected from a group consisting of iron, zinc, aluminum, silicon, n-doped silicon, carbon, alloys of the aforementioned, or combinations of the same.

15. A method of preparing a battery cell comprising:
providing conductive or semiconductive electrode cores, wherein said conductive or semiconductive electrode cores include at least one anode and one cathode, and wherein said electrodes comprise a metal, metal alloy, or ceramic metal glass;
adding at least one ceramic coating layer to each electrode surface, wherein said ceramic coating layer comprises a refractory, modifier, metal, and flux;
heating the electrode and at least one ceramic coating layer in order to fuse the at least one ceramic coating layer, wherein said ceramic coating layer is resistant to corrosion in an electrolyte environment and controls the rate of ion transfer between an electrolyte and the electrode.

16. The method of claim 15 further comprising adding an interfacial core to the conductive or semiconductive electrode cores and optionally adding an outer core to the conductive or semiconductive electrode cores, wherein the ceramic layer.

17. The method of claim 15, further comprising adding at least one additional ceramic coating layer to each electrode surface, wherein said ceramic coating layer comprises a refractory, modifier, metal, and flux; and heating the electrode and at least one additional ceramic coating layer in order to fuse the at least one additional ceramic coating layer.

18. The method of claim 17, wherein the at least one ceramic coating layer and at least one additional ceramic coating layer have eutectic temperatures within a range of about 500° C.

19. The method of claim 15, wherein the heating step is performed under an atmosphere with controlled carbon, nitrogen, and oxygen content.

20. The method of claim 15 further comprising adding an electrolyte composition to the battery cell after the heating step.
